(19) United States
(12) Patent Application Publication
(10) Pub. No.: US 2003/0099910 A1
(43) Pub. Date: May 29, 2003

(54) PHOTOCHROMIC SPIROBENZOPYRAN COMPOUNDS AND THEIR DERIVATIVES, SPIROPYRAN GROUP-CONTAINING POLYMERS, PROCESS FOR PRODUCING THE SAME, COMPOSITIONS COMPRISING SAID SPIROPYRANS OR SPIROPYRAN GROUP-CONTAINING POLYMERS AND PHOTOCHROMIC SWITCH THIN FILMS PREPARED

(76) Inventors: EUN-KYOUNG KIM, DAEJEON (KR); YUN-KI CHOI, DAEJEON (KR); SAM-ROK KEUM, SEOUL (KR)

Correspondence Address: JOHN PALMER, C/O LADAS & PARRY, 5670 WILSHIRE BOULEVARD, SUITE 2100, LOS ANGELES, CA, 900365679

(21) Appl. No.: 09/379,664

(22) Filed: Aug. 24, 1999

(51) Int. Cl. G03C 1/725

(52) U.S. Cl. 430/345; 430/962; 548/357.5; 548/407; 548/408; 548/409; 252/586; 544/70; 549/264; 549/331

(57) ABSTRACT

The present invention relates to a photochromic spirobenzopyran compound of the formula (1) and its derivatives, a spirobenzopyran group having unsaturated terminal groups, a polymer prepared therefrom, a method for the production thereof, a composition comprising said spirobenzopyran or said spirobenzopyran group-containing polymer and a photochromic switch film using the same:

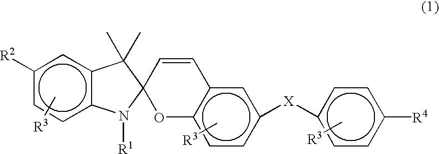

wherein the substituents are defined in the specification. According to the present invention, a polymer which possesses excellent mechanical properties and rapid photochromic switch properties at room temperature and a photochromic thin film for switch elements are produced. They are useful in applications such as photo switches, photochromic filters, light stabilizers, paper money or cards for preventing counterfeit forgeries, display elements, optical recording media or photo integrated elements.

### BACKGROUND OF THE INVENTION

1. Field of the Invention

The present invention relates to a spirobenzopyran compound and its derivative which exhibit fast color change by light as well as high thermal stability and processability, a spirobenzopyran group-containing polymer, a process for producing the same, a composition containing the spirobenzopyran compound or spirobenzopyran group-containing polymer and a photochromic switch thin film prepared therefrom.

2. Background of the Invention

Photochromism is a reversible phenomenon illustrated by a compound which, when exposed to the radiation of light containing ultraviolet rays such as sunlight or the light of a mercury lamp or the light of laser, changes color and then returns to its original color if the radiation is discontinued or the compound is heated or exposed to radiation of different wavelengths.

Various types of photochromic compounds have been suggested for use in applications in which a color change or darkening is induced by light. Among them, spirobenzopyran compounds are expected to be used in applications such as display elements or optical parts since they have photochromic property, photoconductivity, photosensitivity and optical memory properties.

U.S. Pat. Nos. 3,567,605 and 5,238,981 by Becker disclose a series of pyran derivatives including specific benzopyrans and naphthopyrans which exhibit photochromic property. Said compounds are reported to be derivatives of chromen and change color, for example, from a colorless state to yellow-orange color, when exposed to the radiation of ultraviolet rays at a temperature of less than approximately −40° C. Said compounds return to their colorless state on either exposure to visible light or warming to a temperature in the range of between −10° C. and 0° C.

EP-A-246,114 and EP-A-250,193 disclose a series of photochromic spiropyran derivatives in which a spiroadamantane group is attached to the 2-position of a benzopyran or naphthopyran ring. In addition, Japanese Patent Publication Nos. Hei 3-81278, Korean Patent Publication No. 92-8620, EP 0432 841 A2, EP 0600 669 A1 and EP 0600 688 A1 also disclose spirooxazine compounds. U.S. Pat. No. 4,563,458 discloses the use of a specific 2H-chromen as a precursor of specific chroman-4-aldehyde when preparing 4-aminomethylene-chroman and -chromen via the reaction with specific amines for use in medicaments

Japanese Patent Nos. JP 05,181,227 and JP 03,187,637 disclose an optical recording medium utilizing spirobenzopyrans.

EP-A-250,193 discloses photochromic benzopyrans or naphthopyrans, blue in color, which have an aminophenyl substituent at the 2-position of the pyran ring. In addition, EP-A-246,114 discloses photo reactive plastic lenses which are coated or impregnated with a photochromic spiropyran.

J. Org. Chem., Volume 40, No. 8, 1975, page 1142 according to Padwa et al. discloses the research on the photochemical reaction of the compounds described in U.S. Pat. No. 3,567,605 (Becker et al.) and illustrates the identification of byproducts and the pathways which form a ring-opened colored intermediate and a final phenol which is colorless. Padwa reported that the color types of the said compounds are unstable at room temperature.

Herige Heller reported the process for the production of the photochromic benzopyran and naphthopyran compounds in Korean Patent Publication No. 92-8620, however these pyran compounds are spirooxazine compounds, which have associated with them the problem of being difficult to synthesize and thus produce low yields.

Various applications utilizing the photochromic property of the compounds disclosed in the publications noted above are known. For example, European Patent No. 0442166 A1 discloses illuminating systems and illuminators. In addition, other applications such as protection cards (WO 90/06539), photoswitches (K. Sasaki, T. Nagamura, Appl. Phys. Lett., 1997, 71, 4, 434), phtochromic glasses (H. Nakazumi, R. Nagshiro, S. Matsumoto, K. Isagawa, SPIE, vol. 2288, sol-gel optics, III, 1994, 402) and recording mediums (Optical Engineering, 1995, 34, 480) are known.

Among them, compounds possessing a spirobenzopyran unit have advantages in synthesis due to a monochromatic synthetic process in comparison to spirooxazine type compounds. Typical examples are the spirobenzopyran compounds which are substituted with nitro, sulfonic acid or hydroxyl group and are known from JP 03 20 626, JP 02 264 246, JP 04 116 545, JP 04 116 546, EP 0414 476 A1, EP 0483 542 A1 and EP 0502 506 A1. These compounds exhibit deterioration in memory properties after a color change has been induced by light due to their low thermal stability. Furthermore, these compounds have problems in that they also have poor storage stability and light stability.

In addition, the thin films prepared from the polymer resins containing units derived from the conventional spirobenzopyran compounds having a spirobenzopyran skeletal structure have problems in that they are degraded at a temperature of more than 100° C. and that they slowly change color by light due to the formation of aggregate. after photo coloration (Polymer, 1987, Vol 28, 1959, H. Eckhardt, A. Bose, V. A. Krongauz). These problems result in the drawbacks of deteriorating the storage stability and light stability after color change has been induced by light.

The process for the production of a photochromic lens by the use of spirobenzopyran or oxazine type compounds is described in U.S. Pat. No. 4,637,698. In this process, the spirooxazine is either dispersed or dissolved in the polymer matrix and thus a chemical bonding between the spiropyran compound and the polymer matrix does not occur, causing a phase separation between the matrix polymer and the photochromic molecules. This process also has disadvantages in that, when the molecules form melocyanines by light, an aggregation phenomenon may occur, thus causing the polymer matrix to crystallize, which then in turn deteriorates the storage stability and photochromic property after long term use.

Spirobenzopyrans which are substituted with either alkylcarbonyl, alkyl sulfonyl, halogen or amino groups are also known (JP 05 181 227). These compounds show slow color change by light and have low thermal stability.

Accordingly, methods for bonding spirobenzopyrans to a polymer matrix via chemical bonding have been proposed. Among them, N-substituted spiropyran polymers are known in Macromolecules, 1984, 17, 1876, Macromolecules, 1984, 17, 1225 and Macromolecules, 1981, 14, 1382. In these cases, drawbacks are noted in that the polymer chains are partially aggregated after color change by light, or that the polymer has low thermal stability due to the presence of the nitro group at 6-position. In the case of N-substituted spirooxazine polymers (Macromolecules, 1992, 25, 3129), the rate of color change by light was slow.

The present inventors have made extensive studies in order to overcome the aforementioned problems caused in the preparation of the spirobenzopyran compounds and to develop a spirobenzopyran compound and a polymer containing the same which are thermally stable and that have no problems associated with phase separation or formation of aggregate and that exhibit rapid color change by light. As a result, the present inventors have now found that a spirobenzopyran compound substituted with —X—Bz—R⁴ (wherein X is a divalent linking group, Bz is a benzene ring substituted with R³ and R⁴ and is a divalent linking group), represented by the following formula (1), possesses fast color change by light and high thermal heat stability. In our studies, the present inventors have made a number of observations. Firtstly, the spirobenzopyran compound substituted with —X—Bz—R⁴, represented by the following formula (1), can be prepared from a salicyl aldehyde, represented by the following formula (2), which can be substituted, or its derivative and an indoline, represented by the following formula (3), or its derivative. Secondly, a photochromic composition which shows fast color change by light, high thermal heat stability and processability can be produced from thus prepared spirobenzopyran compound. Thirdly, the resulting composition may be coated onto a general support or an electrode such as a glass plate, a plastic plate, an aluminum plate or a myler film, an ITO glass, a PET resin or a platinum electrode to form a photochromic thin film.

In addition, the present inventors have further found that when a compound having the reactivity in R⁴ group among the spirobenzopyran compounds of the formula (1) is reacted with a compound of the following formula (4) to form a modified spirobenzopyran compound derivative, which possesses increased optical properties, mechanical properties and solubility, then this modified spirobenzopyran compound derivative can be further modified by the reaction with the compound of the formula (4) to form a further modified spirobenzopyran compound derivative whose photochromic property, processability and mechanical property are further altered.

Furthermore, it has also been found that these spirobenzopyran compounds and/or their derivatives can be used to form a photochromic thin film in combination with a multi-purpose resin such as polyolefin, polystyrene, poly(meth)acrylic resin, polyvinyl butyral (PVB) or polycarbonate (PC).

The present inventors have found that among the spirobenzopyran compounds, a spirobenzopyran compound having an unsaturated terminal group can be utilized to form a polymer which shows fast color change by light, high thermal stability and processability. Our studies further prove that this prepared polymer can be dissolved in an organic solvent to form a solution which then can be used to form a photochromic switch thin film possessing fast color change by light and high thermal stability. The present invention has been attained on the basis of these findings.

### THE DRAWINGS

FIG. 1 illustrates a variation of the absorption spectrum of the thin film prepared in Example 12 when it is exposed to the radiation of a monochromatic wavelength of 340 nm.

FIG. 2 illustrates a variation of firstly the rate of photo coloration and secondly stability in darkness of the thin film prepared in Example 12 against the radiation of a monochromatic wavelength of 340 nm.

FIG. 3 illustrates a variation of firstly the rate of photo coloration and secondly stability in darkness of the thin film prepared in Example 13 (Comparative Example) against the radiation of a monochromatic wavelength of 340 nm.

FIG. 4 illustrates a variation of firstly the rate of photo coloration and secondly stability in darkness of the thin film prepared in Example 14 against the radiation of a monochromatic wavelength of 340 nm.

FIG. 5 illustrates a variation of the absorption spectrum (light irradiation period: 1, 2.5, 4, 6, 8 and 17 minutes from the bottom) of the thin film prepared in Example 15 when exposed to the radiation of a monochromatic wavelength of 340 nm.

FIG. 6 illustrates a variation of firstly the rate of photo coloration and secondly stability in darkness of the thin film prepared in Example 15 against the radiation of a monochromatic wavelength of 340 nm.

FIG. 7 illustrates a variation in the absorption spectrum (light irradiation period: 1 second, 49 seconds, 1 minute and 37 seconds, 3 minutes and 4 seconds, 4 minutes and 46 seconds, 6 minutes and 23 seconds, from the bottom) of the thin film prepared in Example 40 when exposed to the radiation of a monochromatic wavelength of 340 nm.

FIG. 8 illustrates the effect of the thin film prepared in Example 40 as a photo switch against the radiation of a monochromatic wavelength of 340 nm.

### DETAILED DESCRIPTION

Accordingly, the first and second objectives of the present invention are to provide a spirobenzopyran compound of the formula (1) and its derivatives and a process for the production of the same.

Such a spirobenzopyran compound of the formula (1)

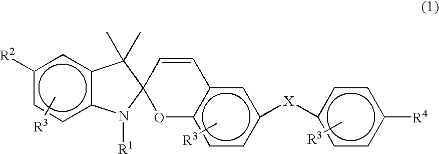

can be prepared by reacting, in the presence of solvent, a carbonyl salicyl aldehyde of the formula (2) or its derivatives

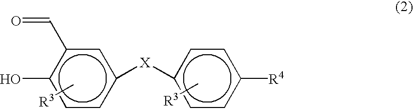

with an indoline of formula (3) or its derivatives

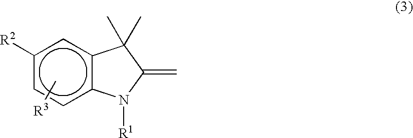

wherein R¹ is a linear or branched C₁₋₂₂ alkyl or alkenyl group, a phenyl or phenylalkyl group, wherein said alkyl, alkenyl and phenyl groups may be substituted with a functional group such as a hydroxyl, a halide (F, Cl, Br, I, At, etc.), a glysidoxy, an amine, a vinyl, an epoxy, a (meth)acryl, an amino or a mercapto group;

R² and R³independently of one another are hydrogen, a halogen atom, a cyano group, a substituted amino group, a nitro group, or a linear or branched C₁₋₁₀ alkyl or alkoxy group which may be substituted;

R₄ is a hydrogen, a hydroxy, —R¹ or —OR group, or —(R⁵)ₙ—Z group wherein R⁵ is a C₁₋₂₂ alkylene which may be substituted and may contain in its carbon chain at least one hetero atom selected from the group consisting of carbon, sulfur and nitrogen, Z is a functional group such as a hydroxyl group, a halide group, a glysidoxy group, an amine group, an epoxy group, an amino group or a mercapto group, or a group having at least one unsaturated linkage (for example, a vinyl group, a (meth)acryl group, etc.) and n is a number of from 0 to 20(or 0, 1, 2, 3, 4, 5, 6, 7, 8, 9, 10, 11, 12, 13, 14, 15, 16, 17, 18, 19, or 20); and

X is a divalent linking group and is —CO—, —S—, —SO₂—, —C≡C—, —O—, —C(R⁶)₂—, —C(R⁶)═C(R⁶)—, —N═N— or —NR⁶— wherein R⁶ is independently selected from the substituents defined for R¹, R² and R³.

Examples of the solvent used in the above reaction include methanol, ethanol, dichloromethane, etc.

The third objective of the present invention is to provide a polymer containing units of the following formula (1a)

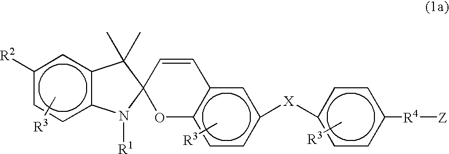

wherein the substituents are defined in the following and a process for the production of the same.

The fourth objective of the present invention is to provide a composition comprising the spirobenzopyran compound of formula (1) or its derivative or the spirobenzopyran group-containing polymer.

The fifth objective of the present invention is to provide a polymer thin film comprising the spirobenzopyran compound of formula (1) and its derivative or the spirobenzopyran group-containing polymer.

The sixth objective of the present invention is to provide articles such as display elements, photochromic filters, photo switches, photosensitive drums, recording elements, solar batteries, cosmetics, fibers or optical elements comprising the spirobenzopyran compound of formula (1) and its derivative or the spirobenzopyran group-containing polymer.

In the following, the present invention is explained in greater detail.

The spirobenzopyran compounds of formula (1) of the present invention have —X—Bz—R⁴ substituted at the 6-position of the spirobenzopyran unit and show fast color change by light and high thermal and photo stability.

Accordingly, the compounds of formula (1) are useful in the various range of applications utilizing a photochromic phenomenon, for example optical integrated elements, photo switches, solar batteries, photochromic filters, paper money or cards for preventing counterfeit forgeries, photochromic fibers, cosmetics or decorative articles, light stabilizers, optical disks, display elements or optical recording media.

The spirobenzopyran compounds of formula (1) of the present invention can be prepared by the following steps:

dissolving a substituted salicyl aldehyde of formula (2) and a substituted indoline of formula (3) in an organic solvent,

adding a basic catalyst to the resulting mixture,

sufficiently stirring the resulting mixture at room temperature in order that the mixture can be well mixed and then

slowly heating the resulting mixture at a temperature of between 30° C. and 150° C., preferably at a temperature between 40° C. and 100° C. for 0.5 to 98 hours, preferably 2 to 36 hours.

Examples of the organic solvent used in the above reaction include alcohol, dichloromethane, tetrahydrofuran (THF), etc., and among them alcohol is particularly preferred.

As a typical example, 6-((p-hydroxyphenyl)carbonyl)-1′,3′,3′-trimethylspiro[2H-1-benzopyran-2,2′-indoline] (corresponds to formula (1)) can be prepared by dissolving 5-((p-hydroxyphenyl)carbonyl)salicyl aldehyde (corresponds to formula (2)) and 2-methylene-1,3,3-trimethylindoline (corresponds to formula (3)) in MeOH, a solvent, mixing them sufficiently at room temperature and slowly heating the resulting mixture at a temperature of between 30° C. and 100° C., preferably from 40° C. to 70° C. for 0.5 to 10 hours, preferably 2 to 10 hours.

The compounds of formula (2) used in the present invention can be prepared from 4,4′-dihydroxybenzophenone by techniques known in the art [Vogel, “A Textbook of practical Organic Chemistry”, 4^{th} ed., p. 762]. The compounds of formula (3) may be commercially available from Aldrich Com., or they may be synthesized by techniques known in the art [Ilona Gruda, Roger M. Leblanc, Can. J. Chem. 54, 576 (1976)]. In addition, the compounds of formula (4) may be obtained from commercial sources or they may be synthesized by techniques known in the art.

According to one aspect of the present invention, the modified spirobenzopyran compound derivative can be obtained by reacting the compound having the reactivity in R⁴ group of the substituent X—Bz—R⁴ among the spirobenzopyran compounds of formula (1) with the compound of the formula

R⁴OH or R⁴Z (4)

wherein R⁴ and Z are defined as in the formula 1.

The above reaction may be carried out with the compound of formula (4) more than once (e.g., one, two, three, four, five, or more times) and the compounds of formula (4) used in the respective modification reaction may be the same or different to each other. In addition, the selected same or different compounds of formula (4) may be reacted previously with each other and then reacted with the compound of formula (1).

According to an embodiment of the process for the production of the modified spirobenzopyran compound derivatives in accordance with the present invention, the spirobenzopyran compound of formula (1) may be dissolved in an organic solvent and the resulting mixture then reacted with the compound of formula (4) in the presence of a basic catalyst at a temperature between 30 and 100° C. for 2 to 48 hours with stirring and if desired, subjected to cooling, washing and purification to form modified spirobenzopyran compound derivatives which possess better processablity. The modified spirobenzopyran compound derivatives having the reactive terminal group by being substituted with a functional group such as a hydroxyl group, a carboxyl group or a halogen group may be further modified via further reaction with a compound of formula (4).

As one example which illustrates modification according to the present invention, the spirobenzopyran compound derivative having the reactive terminal group among the compounds of formula (1), 1-chlorohexanol and K₂CO₃ are placed in CH₃CN, which is then reacted at a temperature of between 30° C. and 100° C. for 5 to 30 hours, preferably 10 to 20 hours under heating and stirring. The resulting mixture is then cooled to room temperature and purified to obtain a modified spirobenzopyran compound derivative according to the present invention.

In addition, the spirobenzopyran compound derivative prepared as described previously may be dissolved in a suitable solvent in the presence of an acidic or a basic catalyst in a similar manner as above, and the resulting mixture then reacted with the same or different compound of formula (4) used in the prior step whilst being heated and stirred to obtain a further modified spirobenzopyran compound. Examples of the acidic catalyst used in the above reaction include hydrochloric acid, sulfuric acid, acetic acid, etc.; examples of the basic catalyst include pyridine, NaOH, Na₂CO₃, NaHCO₃, etc.; and examples of the solvent include ethanol, methanol, THF, etc.

In said compounds according to the present invention, examples of substituted or unsubstituted linear or branched alkyl include hydrocarbons, for example methyl, ethyl, n-propyl, isopropyl, n-butyl, isobutyl, sec-butyl, t-butyl, n-pentyl, isopentyl, neopentyl, 1,2-dimethylpropyl, n-hexyl, cyclohexyl, 1,3-dimethylbutyl, 1-isopropylpropyl, 1,2-dimethylbutyl, n-heptyl, 1,4-dimethylpentyl, 2-methyl-1-isopropylpropyl, 1-ethyl-3-methylbutyl, n-octyl, 2-ethylhexyl, 3-methyl-1-isopropylbutyl, 2-methyl-1-isopropylbutyl, 1-t-butyl-2-methylpropyl, n-nonyl group; alkoxyalkyl groups, for example methoxymethyl, methoxyethyl, ethoxyethyl, propoxyethyl, butoxyethyl, methoxyethoxyethyl, ethoxyethoxyethyl, dimethoxymethyl, diethoxymethyl, dimethoxyethyl and diethoxyethyl; and halogenated alkyl groups, for example chloromethyl, 2,2,2-trichloroethyl, trifluoromethyl, 1,1,1,3,3,3-hexafluoro-2-propyl group.

In said compounds according to the present invention, examples of substituted or unsubstituted alkylene may be referred to corresponding examples for the substituted or unsubstituted linear or branched alkyl group.

The spirobenzopyran compounds and their derivatives of formula (1) provided in accordance with the present invention can be dissolved in a conventional solvent such as chloroform, acetone, acetonitrile, lower alcohol, dimethylformamide (DMF) or dimethylsufoxide (DMSO) in a proportion of approximately 70% by weight.

The spirobenzopyran group-containing polymers according to the present invention refer to polymers which contain units of the following formula (1a)

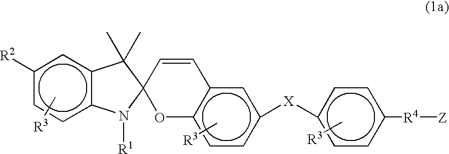

wherein R¹ is a linear or branched C₁₋₂₂ alkyl or alkenyl group, or a phenyl or phenylalkyl group, wherein said alkyl, alkenyl and phenyl groups are capable of being substituted with a functional group such as a hydroxyl, a halide (such as F, Cl, Br, I, At, etc.), a glysidoxy, an amine, a vinyl, an epoxy, a (meth)acryl, an amino or a mercapto group;

R² and R³ independently of one another are a hydrogen, a halogen atom, a cyano group, a substituted amino group, a nitro group, or a linear or branched C₁₋₁₀ alkyl or alkoxy groups which may be substituted;

R⁴ is a linear or branched C ¹⁻²² alkylene or alkyleneoxy group which may contain in its carbon chain at least one hetero atom selected from the group consisting of oxygen, sulfur and nitrogen, wherein said alkylene portion is capable of being substituted with at least one substituent selected from the group consisting of a C₁₋₆ alkyl, an alkenyl, a hydroxyl, a halide (such as F, Cl, Br, I, At, etc.), a glysidoxy, an amine, a vinyl, an epoxy, a (meth)acryl, an amino or a mercapto group;

Z is OH, a halide group or a group having at least one unsaturated linkage (for example, a vinyl group, a (meth)acryl group, etc.); and

X is a divalent linking group and is —CO—, —S—, —SO₂—, —C≡C—, —O—, —C(R⁶)₂—, —C(R⁶)═C(R⁶)—, —N═N— or —NR⁶— wherein R⁶ may independently be selected from the substituents defined for R¹, R² and R³, wherein said units being derived from the spirobenzopyran derivatives of formula (1) and being located in their polymer chain or attached to the polymer chain via chemical bonding. The spirobenzopyran derivatives of formula (1a) used in the present invention are characterized in that they are substituted with X—Bz—R⁴—Z at the 6-position of the spirobenzopyran skeletal structure and their terminal group —Z is OH, a halide group or a functional group having at least one unsaturated linkage.

The spirobenzopyran derivatives of formula (1a) can be prepared from a substituted salicyl aldehyde and a substituted indoline. As an example, 6-[4″-(6′″-(methacryloxyhexyloxyphenylcarbonyl)-1′,3′,3′-trimethylspiro[2H-1-benzopyran-2,2′-indoline] may be prepared by reacting 6-((hydroxyhexyloxyphenylcarbonyl)-1′,3′,3′-trimethylspiro[2H-1-benzopyran-2,2′-indoline] with methacryl chloride in the presence of a catalyst at room temperature. The ¹H-NMR (CDCl₃) spectrum measured by using a solution obtained by dissolving said synthesized spirobenzopyran compounds in CDCl₃ shows peaks at δ 7.79 (d, 2H, J=8.7 Hz), 7.60 (s, 1H), 7.57 (d, 1H, J=8.1 Hz), 7.19 (t, 1H, J=7.6 Hz), 7.10 (d, 1H, J=7.1 Hz), 6.96-6.83 (m, 4H), 6.76 (d, 1H, J=8.1 Hz), 6.56 (d, 1H, J=7.7 Hz), 6.11 (s, 1H), 5.76 (d, 1H, J=10.3 Hz), 5.54 (s, 1H), 4.18 (t, 2H, J=6.6 Hz), 4.05 (t, 2H, J=6.3 Hz), 2.74 (s, 3H), 1.83 (m, 2H), 1.73 (m, 2H), 1.57-1.38 (m, 4H), 1.32 (s, 3H), 1.17 (s, 3H). These peak results are characteristic of a spirobenzopyran ring and methacrylic unit as an unsaturated terminal group. The TGA analysis measuring the weight loss against heat reveals that the spirobenzopyran compounds have good heat stability as they exhibit a thermal decomposition initiation temperature of more than 226° C.

In the compounds of formula (1a) according to the present invention, examples of the substituted or unsubstituted linear or branched alkyl groups or substituted or unsubstituted alkylene groups are defined as for the compounds of the formula (1).

The spirobenzopyran derivatives of formula (1) according to the present invention show fast color change by light and high thermal and photo stability, and thus can be used in applications utilizing the photochromic property of the derivatives of formula (1), for example, optical integrated elements, photo switches, solar batteries, photochromic filters, paper money or cards for preventing counterfeit forgeries, photochromic fibers, cosmetics or decorative articles, light stabilizers, optical disks, display elements or optical recording media.

According to the third objective of the present invention, a spirobenzopyran group-containing polymer can be prepared by polymerizing by either heat curing or light curing, in the presence of an initiator and in the absence or presence of solvent, a spirobenzopyran monomer of formula (1a)

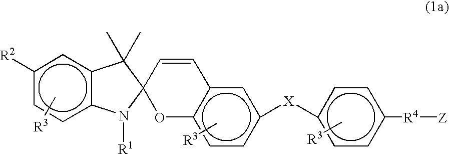

and as a comonomer, at least one unsaturated functional group-containing monomer selected from the group consisting of the compounds of the formula (200)

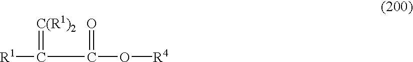

and compounds of the formula (300)

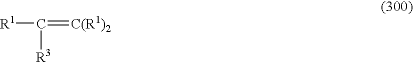

wherein R¹, R², R³, R⁴, Z and X are as defined above.

In the method for the production of the compounds of formula (1a), the compounds of formulae (200) and (300) are commercially available.

In particular, the spirobenzopyran group-containing polymers according to the present invention can be prepared by dissolving the spirobenzopyran compound of formula (1a) and as a comonomer, at least one compound selected from the group consisting of the compounds of formulae (200) and (300) in an optionally selected organic solvent, and then polymerizing the resulting mixture by slowly heating at a temperature of between 30° C. and 150° C., preferably from 40° C. to 120° C. for 0.5 to 150 hours, preferably 2 to 100 hours in the presence of the conventionally used heat curing agent. Examples of the organic solvent used in the above reaction include THF, toluene, benzene, ethylbenzene, diphenylether, etc. Examples of the heat curing agent include dibenzoylperoxide (BPO), azobisisobutyronitrile (AIBN), t-butylperoxalate (PBPOX), etc.

In the spirobenzopyran group-containing polymers, the proportion of the units derived from the spirobenzopyran monomer is not specifically limited, however in general it is between 0.01 to 99.99% by weight, 0.1 to 99% by weight, 1 to 90% by weight, or preferably 5 to 70% by weight, or more preferably 10 to 50% by weight.

For example, photochromic spirobenzopyran group-containing polymers can be prepared by dissolving as a monomer, 5% by mole of 6-[4″-(6′″-(methacryloxyhexyloxyphenylcarbonyl)-1′,3′,3′-trimethylspiro[2H-1-benzopyran-2,2′-indoline] and as a comonomer, 67% by mole of styrene and 28% by mole of butyl methacrylate in THF and then adding a heat curing agent to the resulting mixture. This resulting mixture is then subjected to a heat reflux under nitrogen atmosphere.

Thus prepared polymers have an average molecular weight of approximately 12,000 and a dispersibility (M_{w}/Mₙ) of 1.68. They can act as photochromic polymers since they can be dissolved in a solution and easily processed. The ¹H-NMR (CDCl₃) spectrum of thus prepared spirobenzopyran group-containing polymers shows peaks at δ 8 7.79 (d, J=8.7 Hz), 7.60 (s), 7.3-6.5 (m, broad), 5.76 (d, J=10.3 Hz), 4.0-3.0 (m, br), 2.74 (s), 2.3(br), 2.0-1.0 (m, br), 0.9-0.5 (m, br), which correspond to the characteristic peaks of the spirobenzopyran skeletal structure. The infrared spectral absorption spectrum of said spirobenzopyran group-containing polymers shows peaks at 1724 cm⁻¹ and 955 cm⁻¹, which correspond to the characteristic peaks of the spirobenzopyran skeletal structure.

The result of TGA, determining the weight loss against heat, of the spirobenzopyran group-containing polymers prepared from 10% by mole of 6-[4″-(6′″-(methacryloxyhexylphenylcarbonyl)-1′,3′,3′-trimethylspiro[2H-1-benzopyran-2,2′-indoline] exhibits a decomposition initiation temperature of greater than 242° C., which demonstrates high thermal stability.

The spirobenzopyran group-containing polymers according to the present invention, can be dissolved in a conventional solvent such as toluene, xylene, chloroform, acetone, acetonitrile, lower alcohol, dimethylformamide (DMF) and dimethylsulfoxide (DMSO) or a mixture of them.

The fourth objective of the present invention is to provide a composition comprising a spirobenzopyran compound, its derivative, or a spirobenzopyran group-containing polymer, as a main component, possessing high thermal is stability. Compositions provided by the present invention are as follows:

(i) Composition comprising 5 to 99% by weight, preferably 10 to 90% by weight of at least one solvent selected from the group consisting of conventional organic solvent such as chloroform, hexane, acetone, acetonitrile, lower alcohol, 1,2-dichloroethane, dimethylformamide (DMF), water, dimethylsulfoxide (DMSO), sulfolane, xylene, 3-nitro-α,α,α-trifluoronitro toluene or a mixture of them and 1 to 95% by weight, preferably 10 to 90% by weight of a compound of the spirobenzopyran compound of the formula (1) according to the present invention or a spirobenzopyran group-containing polymer according to the present invention;

(ii) Composition comprising 1 to 80% by weight, preferably 10 to 50% by weight of at least one further compound selected from the group consisting of tetraalkoxy silane, trialkoxy glycidyl silane, hydrochloric acid and organic acid in addition to said composition (i);

(iii) Composition comprising at least one resin selected from the group consisting of polyolefin, polystyrene, polyvinylbutyral, polycarbonate, polyester, poly(meth)acrylate and polyurethane and 1 to 90% by weight, preferably 10 to 70% by weight of a spirobenzopyran compound of the formula (1) or a spirobenzopyran group-containing polymer according to the present invention in the presence or absence of the aforementioned solvent.

The polymer compositions as mentioned above may comprise at least one further high boiling point solvent selected from the group consisting of α-methylnaphthalene, methoxynaphthalene, chloronaphthalene, diphenylethane, ethylene glycol, sulfolane, quionoline, dichlorobenzene, dichlorotoluene, propylenecarbonate and xylene.

The component ratio of the compositions according to the present invention can vary according to the intended use of the compositions. In the case where the compositions are used for the production of photochromic thin film as mentioned below, it is preferable that the spirobenzopyran compound of formula (1) is used in an amount of 0.01 to 70% by weight and other components are used in an amount of 99.99 to 30% by weight on the basis of the total weight of the compositions. On the other hand, it is preferable that the spirobenzopyran group-containing polymer is used in an amount of 10 to 90% by weight and other components are used in an amount of 90 to 10% by weight on the basis of the total weight of the composition. If the component ratio of the compositions of the present invention exceeds the aforementioned component ratio range, the mechanical properties of the thin film to be prepared may become disadvantageously deteriorated.

Furthermore, when the spirobenzopyran compound of the present invention is used as a light stabilizer or for any other use in cosmetics, fibers, clay and other compositions, it may be used in trace amounts of from 0.01% by weight to several (e.g., 2, 3, 4, 5, or 2-10) ppm.

The polymer compositions of the present invention may include further various additives, lubricants and thickeners well known to a person skilled in the art in order to improve the heat resistance properties, mechanical properties and processing properties of the polymer compositions.

The fifth objective of the present invention is to provide a photosensitive thin film which is prepared from the composition comprising a sirobenzopyran compound of formula (1) or its derivative or a spirobenzopyran group-containing polymer according to the present invention, the thin film being characterized by possessing a sensitivity against ultraviolet rays, visible light and near infrared light in the range of 200 to 800 nm.

The photosensitive thin film according to the present invention can be obtained by applying a composition composed of a compound of formula (1) or its derivative or the spirobenzopyran group-containing polymer, an optional solvent and/or other polymer onto a general support such as plastic resins, glass plates, aluminum plates, myler films or conductive glasses and then drying in a conventional manner. The resulting thin film obtained shows high absorbance in the wavelength range of 200 to 500 nm. When thus prepared thin film is exposed to light such as sunlight in the range of visible light or ultraviolet rays, it shows high absorbance in the wavelength of 300 to 800 nm.

In the production of the photosensitive thin film according to the present invention, typical examples of said support include conductive electrode supports selected from the group consisting of aluminum foils, aluminum drums, aluminum plates, platinum, myler films, copper plates, conductive glasses and conductive plastics, or insulating supports selected from the group consisting of polypropylene, propylene carbonate, polymethacrylate, polyurethane, other plastics and glass.

The coating may be conducted by employing roll coating, spin coating, bar coating, spray coating or dip coating method.

Alternatively, the spirobenzopyran compound of formula (1) or its derivative or the spirobenzopyran group-containing polymer or the composition comprising the same is mixed and milled together with an optional solvent selected from the group consisting of ethers, alcohols, aromatic hydrocarbons, monoterpene hydrocarbons and liquid paraffins and their mixture and other conventional polymers such as polyvinyl butyral (PVB) and polycarbonate (PC) as mentioned above, and the resulting mixture then applied onto the support mentioned above and finally dried to produce a photochromic thin film.

The spirobenzopyran compounds or its derivative or the spirobenzopyran group-containing polymers according to the present invention are capable of being processed in solution and exhibit absorption peaks in the wavelength range of 200 to 800 nm and a thermal stability at higher than 220° C. or 240° C., and thus are useful in applications such as other recording elements and optical elements including display elements, photo switch elements, optical integrated elements, solar batteries and sensors.

The present invention, therefore, relates to a display element, a photochromic filter, a photo switch, a photosensitive drum, a recording element, a solar battery, a lens, a cosmetic, a fiber or an optical element, which is characterized by comprising at least one spirobenzopyran compound or spirobenzopyran group-containing polymer according to the present invention.

### EXAMPLE

The present invention is described in more detail by referring to the following examples without limiting the scope of the invention in any way.

### Reference Examples 1 and 2

### Preparation of Substituted Salicyl Aldehyde

### Reference Example 1

### Preparation of 5-{(p-hydroxyphenyl) carbonyl}salicyl aldehyde

5 g (23.34 mmole) of 4,4′-dihydroxybenzophenone which is commercially available was added to 150 ml of distilled water wherein 9.3 g (233.4 mmole) of NaOH was dissolved. To the resulting mixture, 3.7 ml (46.68 mmole) of CHCl₃ was added in dropwise while keeping the temperature at 65° C. The reaction mixture was reacted under reflux for 16 hours and then cooled to room temperature. After acidifying the resulting mixture with 2N HCl, the resulting mixture was extracted with ethyl acetate three times. The organic phase was dried over anhydrous MgSO₄ and then subjected to isolation with the use of mixed organic solvent (ethyl acetate:hexane=1:4) to obtain 1.6 g of 5-[(p-hydroxyphenyl)carbonyl]salicyl aldehyde as a white solid state.

IR (KBr, cm⁻¹): 1653 (—CHO group);

¹H-NMR (300 MHz, acetone-d₆): δ 11.25 (s, 1H), 10.01 (s, 1H), 9.20 (s, 1H), 8.08 (s, 1H), 7.88 (d, 1H, J=8.6 Hz), 7.60 (d, 2H, J=8.7 Hz), 6.99 (s, 1H, J=8.6 Hz), 6.84 (d, 2H, J=8.7 Hz);

MS (m/z): 242 (M⁺, 75), 213(18), 149(51), 121(100), 93(23), 65(27).

### Reference Example 2

### Preparation of 3-(p-hydroxyphenylsulfanyl) salicyl aldehyde

3 g (13.61 mmole) of 4,4′-thiophenol was dissolved in 100 ml of toluene. To the resulting mixture, 0.35 ml (d=2.226, 2.994 mmole) of SnCl₄ and 2.59 ml (d=0.778, 10.89 mmole) of tributylamine were added and reacted under a nitrogen stream at room temperature for 30 minutes. To this, 2.06 g (65.3 mmole) of paraformaldehyde was added and refluxed under a nitrogen stream for 8 hours and cooled to room temperature. The resulting mixture was acidified with the use of 2M HCl solution to pH 2 to 3, extracted with ethyl acetate and dried over anhydrous MgSO₄ and the solvent was then removed therefrom under reduced pressure to give a crude 3-p-hydroxyphenylsulfanyl)salicyl aldehyde, which was subsequently subjected to benzophenone isolation with the use of mixed organic solvent (ethyl acetate:hexane=1:4) to obtain 1.38 g (41%) of 3-(p-hydroxyphenylsulfanyl)salicyl aldehyde as a pale yellow color in a purity of more than 99%.

Melting point: 97-98° C.;

IR (KBr, cm⁻¹): 3431 (s), 1642(s), 1491 (m), 1264(s), 1165(s), 837 (s), 707 (m);

¹H-NMR (300 MHz, CDCl₃): δ 10.97, 7.49, 7.46, 6.93, 9.79, 7.28, 6.82, 5.81, 8.6, 8.8;

MS (m/z): 246 (M⁺, 100).

### Examples 1 to 4

### Preparation of Spirobenzopyran Compounds

### Example 1

### Synthesis of 6-{(p-hydroxyphenyl)carbonyl}-1′,3′,3′-trimethylspiro[2H-1-benzopyran-2,2′-indoline

4.0 g (16.51 mmole) of 5-{(p-hydroxyphenyl)carbonyl}salicyl aldehyde prepared in Reference Example 1 and 2.92 ml (16.51 mmole) of commercially available 2-methylene-1,3,3-trimethylindoline were dissolved in 50 ml of MeOH and then stirred at 50° C. for 3 hours. The reaction mixture was cooled to room temperature and then the solvent was removed therefrom under reduced pressure to give a crude product, which was then purified by a colum chromatography [ethyl acetate:hexane =1:4] to give 3.6 g of 6-{(p-hydroxyphenyl)carbonyl}-1′,3′,3′-trimethylspiro[2H-1-benzopyran-2,2′-indoline in a solid state.

The prepared 6-{(p-hydroxyphenyl)carbonyl}-1′,3′,3′-trimethylspiro[2H-1-benzopyran-2,2′-indoline was dissolved in CDCl₃ and the resulting solution was used to measure its ¹H-NMR and infrared spectral absorption spectrum. The results are as follows:

¹H—NMR (300 MHz, CDCl₃): δ 9.86 (s, 1H), 7.74 (d, 2H, J=8.6 Hz), 7.61 (s, 1H), 7.59 (d, 1H), 7.21 (t, 1H), 7.09 (d, 1H), 7.01 to 6.82 (m, 4H), 6.76 (d, 1H, J=7.8 Hz), 6.55 (d, 1H, J=7.6 Hz), 5.76 (d, 1H, J=10.3 Hz), 2.77 (s, 3H), 1.33 (s, 3H), 1.19 (s, 3H);

¹³C-NMR δ 20.4, 26.3, 29.3, 52.4, 105.8, 107.3, 115.2, 115.7, 116.6, 118.8, 119.8, 120.7, 121.9, 128.1, 129.8, 130.2, 130.4, 132.9, 133.1, 136.8, 148.4, 158.7, 161.1, 195.7.

MS(m/z); 397(M⁺, 63), 382(34), 368(7), 262(12), 159(100), 121(23);

IR (KBr, cm⁻¹): 952 (Cₛₚᵢᵣₒ—O);

High-Resolution MS;

C₂₆H₂₃O₃N calculated: 397.1678

determined: 397.1675

### Example 2

### Synthesis of 6-(p-hydroxyphenylsulfanyl)-1′,3′,3′-trimethylspiro[2H-1-benzopyran-2,2′-indoline

1.0 g (4.064 mmole) of 3-(p-hydroxyphenylsulfanyl)salicyl aldehyde prepared in Reference Example 2 and 0.72 ml (4.064.mmole) of Fischer base were dissolved in 50 ml of MeOH and then reacted at room temperature for 3 hours.

The reaction mixture was cooled to room temperature and the solvent was then removed therefrom under reduced pressure to give a crude product, which was then purified by column chromatography [ethyl acetate:hexane=1:4] to give 1.55 g (yield: 95%) of 6-(p-hydroxyphenylsulfanyl)-1′,3′,3′-trimethylspiro[2H-1-benzopyran-2,2′-indoline.

The data of the ¹H-NMR and IR spectrum of thus obtained compound are as follows:

Melting point: 72° C.;

MS(m/z): 401(M⁺, 100);

IR (KBr, cm⁻¹): 3361 (s), 2966 (m), 1604 (m), 1489 (s), 1261 (s), 1124 (m), 962 (m);

¹H-NMR (300 MHz, CDCl₃): δ 5.68, 6.78, 7.04, 7.05, 6.63, 7.07, 6.85, 7.17, 6.53, 1.17, 1.26, 2.72, 7.23, 6.76, 10.2, 8.4, 7.3, 8.3, 7.7, 8.7.

¹³C-NMR (CDCl₃): δ 131.04, 50, 51.76, 121.47, 119.19, 127.59, 106.80, 25.78, 20.10, 28.86, 148.03, 136.59, 120.01, 129.44, 128.90, 126.56, 132.67, 115.86, 153.83, 119.51, 126.98, 133.08, 116.27, 155.20.

### Example 3

3.6 g (9.06 mmole) of the spirobenzopyran compound prepared in Example 1, 1.51 ml (10.87 mmole) of 6-chlorohexanol and 1.63 g (11.78 mmole) of K₂CO₃ were added to 60 ml of CH₃CN and stirred under reflux for 16 hours. The resulting mixture was cooled to room temperature and filtered to remove unreacted K₂CO₃ and then the solvent was removed therefrom under reduced pressure to give a crude spirobenzopyran compound in a solid state, which was purified by column chromatography to obtain 2.6 g of 6-(p-hydroxyhexyloxy)phenylcarbonyl)-1′,3′,3′-trimethylspiro[2H-1-benzopyran-2,2′-indoline]. The data of the ¹H-NMR and IR spectrum of the modified spirobenzopyran are as follows:

IR (KBr, cm⁻¹): 953 (Cₛₚᵢᵣₒ—O);

¹H-NMR (300 MHz, CDCl₃): δ 9.87 (s, 1H), 7.79 (d, 2H, J=8.7 Hz), 7.60 (s, 1H), 7.58 (d, 1H, J=8.0 Hz), 7.19 (t, 1H), 7.08 (d, 1H, J=6.6 Hz), 7.02˜6.81 (m, 4H), 6.74 (d, 1H, J=8.0 Hz), 6.52 (d, 1H, J=7.7 Hz), 5.75 (d, 1H), J=10.3 Hz), 4.05 (t, 2H, J=6.4 Hz), 3.67 (t, 2H, J=6.0 Hz), 2.75 (s, 3H), 1.83 (m, 2H), 1.67˜1.38 (m, 6H), 1.31 (s, 3H), 1.19 (s, 3H);

¹³C-NMR: δ 20.4, 25.9, 26.2, 29.3, 29.5, 33.0, 52.4, 63.2, 68.5, 105.7, 107.3, 114.3, 115.0, 118.8, 119.8, 120.6, 121.9, 128.1, 129.5, 129.6, 130.7, 130.8, 132.4, 132.6, 132.9, 136.9, 148.4, 158.4, 162.8, 194.7;

MS(m/z): 497(M⁺, 36), 482(8), 368(7), 173(43), 158(100), 143(12), 121(11);

High-Resolution MS;

C₃₂H₃₅NO₄ calculated: 497.2566

determined: 497.2568.

### Example 4

1.0 g (2.490 mmole) of the spirobenzopyran compound prepared in Example 2, 0.40 ml (d=1.024, 3.01 mmole) of 6-chlorohexanol and 0.45 g (3.26 mmole) of K₂CO₃ were added to 20 ml of CH₃CN and stirred under reflux for 16 hours. The resulting mixture was cooled to room temperature and filtered to remove unreacted K₂CO₃ and then the solvent was removed therefrom under reduced pressure to give a crude spirobenzopyran compound in a solid state, which was purified by column chromatography [ethyl acetate:hexane =1:4] to obtain 1.14 g (yield: 91%) of 6-[4″-(6″-hydroxyhexyloxy)phenylsulfanyl)-1′,3′,3 ′-trimethylspiro[2H-1-benzopyran-2,2′-indoline] of a red color. The data of the ¹H-NMR and IR spectrum of the thus obtained compound are as follows:

IR (KBr, cm⁻¹): 3382 (s), 2932 (s), 1600 (m), 1488 (s), 1247 (s), 1123 (m), 962(m), 741 (m);

MS(m/z): 500(M⁺, 52),

¹H-NMR (300 MHz, CDCl₃): δ 5.68, 6.76, 7.04, 7.06, 6.60, 7.07, 6.83, 7.10, 6.52, 1.15, 1.28, 2.71, 7.28, 6.82, 3.93, 1.78, 1.35˜1.64, 1.59, 3.65, 10.3, 8.9, 7.3

### Examples 5 to 8

### Preparation of Photochromic Compositions

30 mg of the spirobenzopyran compound prepared in the above mentioned examples, as listed in the following Table 1, was dissolved in I ml of chloroform and to the resulting mixture, 70 mg of conventional multi-purpose resin was added and stirred at room temperature to obtain a polymer composition comprising the spirobenzopyran compound, wherein said composition exhibited viscosity properties.

TABLE 1

| | Spirobenzopyran | | |
|---|---|---|---|
| Examples | compounds used | Solvent | Polymer |
| 5 | Compound of | Chloroform | Polystyrene resin |
| | Example 1 | | |
| 6 | Compound of | Chloroform | Polystyrene resin |
| | Example 3 | | |
| 7 | Compound of | Chloroform | Polystyrene resin |
| | Example 4 | | |
| 8 | Compound of | Chloroform | Polymethyl- |
| | Example 3 | | methacrylate resin |

### Example 9

70 mg of polyolefin, 1 ml of toluene and 1 ml of xylene were mixed and at 100° C. for 1 hour. To the resulting solution, 30 mg of the spirobenzopyran compound as prepared in Example 3 was added and stirred to obtain a polymer composition exhibiting viscosity properties.

### Example 10

0.074 g of the spirobenzopyran compound prepared in Example 3, 3.3 g of tetraethoxysilane, 6.84 g of aqueous hydrochloric acid solution (0.15M), 23.96 g of ethanol and 2.574 g of dimethylformamide were mixed and stirred for 24 hours and then stirred at 60° C. for 22 hours. Thus prepared composition was concentrated slowly under reduced pressure for 17 hours to give a photochromic composition exhibiting viscosity properties.

### Example 11

A composition was prepared in the same manner as in Example 10 except that the spirobenzopyran compound prepared in Example 6 was used instead of the spirobenzopyran compound prepared in Example 5.

### Examples 12 to 31

### Preparation of Photochromic Thin Films and Measurement of Photochromic Property

### Example 12

The composition prepared in Example 6 was applied by a spin coater to a glass plate at a speed of 1000˜2000 rpm and thus prepared coating was dried at room temperature for 30 minutes and then dried again in a vacuum oven to give a transparent photochromic thin film. The prepared thin film changed its color to blue when exposed to the radiation of a monochromatic wavelength of 340 nm.

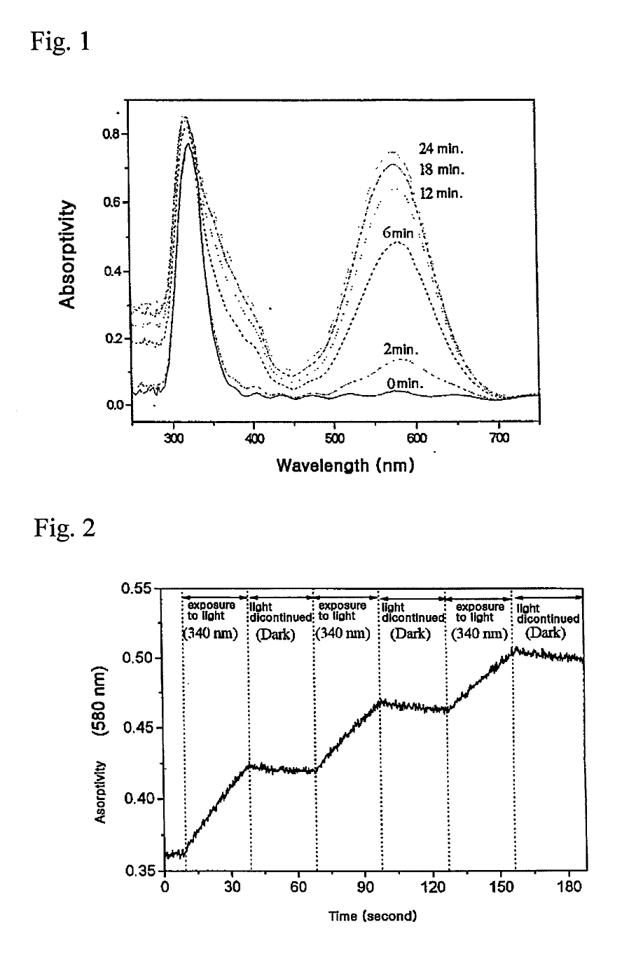

FIG. 1 shows a variation of the spectral absorption spectrum of thus prepared thin film when exposed to the radiation of a monochromatic wavelength of 340 nm.

FIG. 2 shows a variation of the absorption of thus obtained thin film when exposed to light to cause photo coloration and stability in darkness of the prepared thin film when the radiation was discontinued. The rate of darkening to the rate of photo coloration is not more than 11%, which demonstrates stability in the dark.

The TGA analysis of the prepared thin film reveals a thermal decomposition initiation temperature of 230° C. or more.

### Example 13 (Comparative Example)

30 mg of commercially available nitrospirobenzopyran compound was dissolved in 1 ml of chloroform and to this, 70 mg of polystyrene was added and stirred at room temperature to obtain a spirobenzopyran compound composition exhibiting viscosity properties. Thus obtained composition was processed in the same manner as in Example 14 to obtain a photochromic thin film.

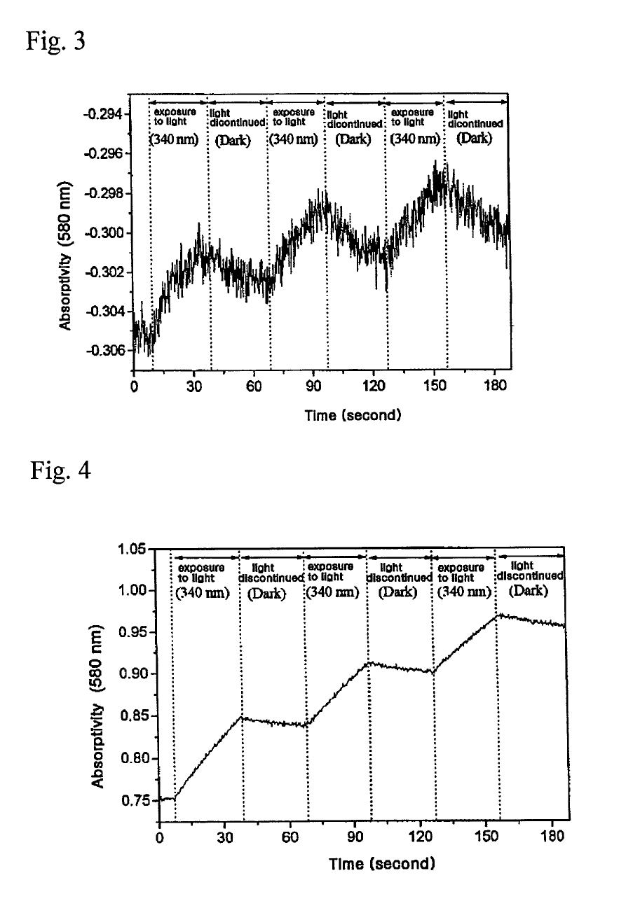

FIG. 3 illustrates a variation of the absorption of the prepared thin film when exposed to light to cause photo coloration and stability in darkness of the prepared thin film when the radiation was discontinued. The rate of darkening to the rate of photo coloration is more than 90%, which demonstrates very weak stability in the dark.

The TGA analysis of the prepared thin film revealed a thermal decomposition initiation temperature of 165° C., which was much inferior to that of the thin film prepared in Example 12.

### Example 14

Thin film was prepared by using a polymer composition prepared in Example 8 in the same manner as in Example 12. The prepared thin film changed its color to blue when exposed to the radiation of a monochromatic wavelength of 340 nm and changed color to yellow when exposed to monochrome light of 580 nm.

FIG. 4 shows a variation of the absorption of the thin film when exposed to light to cause photo coloration and stability in darkness when the radiation was discontinued. The rate of darkening to the rate of photo coloration is not more than 10%, which demonstrates stability in the dark.

### Example 15

The polymer composition prepared in Example 9 was applied by means of a bar coater to a preheated glass plate while placing the glass plate on a hot plate of 100° C. The solvent was then removed at 70° C. and the remainder of the composition dried in a vacuum oven to give a transparent photochromic thin film.

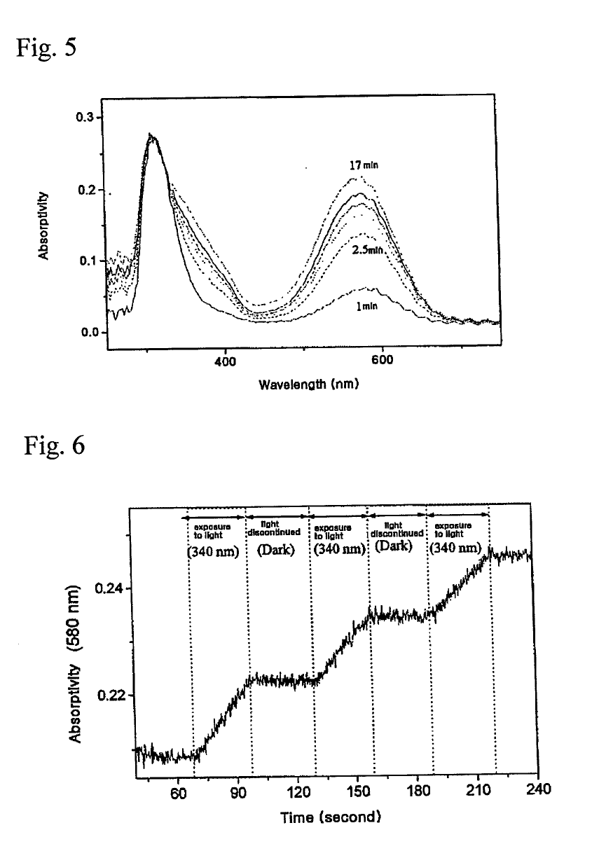

The prepared thin film changed its color to blue when exposed to radiation having a monochromatic wavelength of 340 nm. FIG. 5 illustrates a variation of the absorption spectrum in this case.

FIG. 6 illustrates a variation of the absorption of the thin film when exposed to light to cause photo coloration and stability in darkness of the prepared thin film when the radiation was discontinued. The rate of darkening to the rate of photo coloration is not more than 3%, which demonstrates stability in the dark.

### Examples 16 to 19

The thin films prepared in Examples 12 to 16 were exposed to the radiation of ultraviolet rays to obtain thin films having absorption peaks at wavelengths of 400˜700 nm

### Example 20

The composition prepared in Example 10 was applied by means of a bar coater to a preheated glass plate while placing the glass plate on a hot plate of 100° C. The solvent was then removed at 70° C. and the remainder of the composition dried in a vacuum oven to give a transparent photochromic thin film. The prepared thin film changed color to blue when exposed to radiation having a monochromatic wavelength of 340 nm.

### Example 21

The composition prepared in Example 10 was applied by a spin coater to a glass plate at a speed of 1000˜2000 rpm and thus prepared coating was dried at room temperature for 2 hours and then dried again in a vacuum oven at 60° C. for 8 hours and finally dried in an oven at 80° C. for 12 hours to give a transparent photochromic thin film. The prepared thin film showed 60% of rate of darkening to the rate of photo coloration.

### Examples 22 to 31

Photochromic thin films were prepared in the same manner as in Examples 12 to 21 except that a plastic resin was used instead of a glass plate.

### Examples 32 and 33

### Preparation of Substituted Spirobenzopyran Monomer

### Example 32

Preparation of 6-[4″-(6′″-(methacryloxyhexyloxyphenylcarbonyl)-1′,3′,3′-trimethylspiro[2H-1-benzopyran-2,2′-indoline]

2.0 g (4.02 mmole) of 6-(hydroxhexyloxyphenylcarbonyl)-1′,3′,3′-trimethylspiro[2H-1-benzopyran-2,2′-indoline] prepared according to Example 3 was dissolved in 50 ml of THF and to this, 0.51 ml (5.23 mmole) of triethylamine was added and then 0.51 ml (5.23 mmole) of methacryl chloride was added slowly while stirring. The resulting mixture was reacted at room temperature under stirring for 3 hours and the resulting solid was removed by filtration. The filtrate solution was evaporated under reduced pressure. The resulting solid was dissolved in dichloromethane and washed with an aqueous saturated NaHCO₃ solution. An organic layer was dried over MgSO₄ and purified by a silicagel column chromatography to obtain 2.23 g (yield 98%) of 6-[4″-(6′″-(methacryloxyhexyloxyphenylcarbonyl)-1′,3′,3′-trimethylspiro[2H-1-benzo pyran-2,2′-indoline] as a solid state.

The measurement of TGA, exhibiting weight loss against heat, of thus prepared spirobenzopyran compounds reveals a thermal decomposition initiation temperature of more than 226° C., which demonstrates good heat stability.

IR (KBr, cm⁻¹): 1718 (—COO—), 953 (Cₛₚᵢᵣₒ—O);

¹H-NMR (300 MHz, CDCl₃): δ 7.79 (d, 2H, J=8.7 Hz), 7.60 (s, 1H), 7.57 (d, 1H, J=8.1 Hz), 7.19 (t, 1H, J=7.6 Hz), 7.10 (d, 1H, J=7.1 Hz), 6.96˜6.83 (m, 4H), 6.76 (d, 1H, J=8.1Hz), 6.56 (d, 1H, J=7.7 Hz), 6.11 (s, 1H0, 5.76 (d, 1H, J=10.3 Hz), 5.54 (s, 1H), 4.18 (t, 2H, J=6.6 Hz), 4.05 (t, 2H, J=6.3 Hz), 2.74 (s, 3H), 1.83 (m, 2H), 1.73 (m, 2H), 1.57-1.38 (m, 4H), 1.32 (s, 3H), 1.17 (s, 3H);

¹³C-NMR: δ 10.7, 20.4, 26.1, 26.2, 26.3, 28.9, 29.3, 29.4, 32.4, 65.0, 68.4, 105.7, 107.3, 114.3, 115.0, 118.8, 119.8, 120.6, 121.9, 125.7, 128.1, 129.5, 130.7, 130.9, 132.6, 132.9, 136.9, 148.4, 158.4, 162.8, 194.7;

MS(m/z): 565(M⁺, 75), 550(17), 368(8), 159(100), 121(13);

High-Resolution MS;

C₃₆H₃₉NO₅ calculated: 565.2828

determined: 565.2832

### Example 33

Preparation of 6-[4″-(6′″-(methacryloxyhexyloxyphenylsulfanyl)-1′,3′,3′-trimethylspiro[2H-1-benzopyran-2,2′-indoline]

The same procedure as in Example 32 was repeated except that 6-((hydroxyhexyloxyphenylsulfanyl)-1′,3′,3′-trimethylspiro[2H-1-benzopyran-2,2′-indoline] prepared according to Example 4 was used in place of 6-(hydroxyhexyloxy phenylcarbonyl)-1′,3′,3′-trimethylspiro[2H-1-benzopyran-2,2′-indoline] used in Example 32 to obtain a titled compound in a yield of 98%.

IR (KBr, cm⁻¹): 1718 (—COO—), 962 (Cₛₚᵢᵣₒ—O);

¹H-NMR (300 MHz, CDCl₃): δ 7.27 (d, 2H, J=8.8 Hz), 7.15 (t, 1H), 7.08-7.02 (m, 3H), 6.94-6.80 (m, 3H), 6.75 (d, 1H, J=10.2 Hz), 6.63 (d, 1H, J=9.1 Hz), 6.51 (d, 1H, J=7.7 Hz), 6.08 (s, 1H), 5.68 (d, 1H, J=10.2 Hz), 5.52 (s, 1H), 4.14 (t, 2H, J=6.6 Hz), 3.91 (t, 2H, J=6.4 Hz), 2.70 (s, 3H), 1.82-1.66 (m, 4H), 1.53-1.39 (m, 4H), 1.31 (s, 3H), 1.14 (s, 3H);

¹³C-NMR: δ 18.3, 20.1, 25.7, 25.8, 28.6, 28.9, 29.1, 51.8, 64.6, 67.9, 104.5, 106.8, 15.3, 115.9, 119.2, 119.5, 120.0, 121.5, 125.3, 126.7, 126.9, 127.6, 129.0, 129.4, 132.7, 133.0, 136.5, 136.6, 148.1, 153.9, 158.6, 167.5;

MS(m/z): 569(M⁺, 100), 554(7), 469(5), 444(9), 380(10), 159(56);

High-Resolution MS;

C₃₅H₃₉NO₄S calculated: 569.2600

determined: 569.2591

### Examples 34-37

### Preparation of Spirobenzopyran Group-Containing Polymers

### Example 34

0.5 g of 6-[4″-(6′″-(methacryloxyhexyloxyphenylcarbonyl)-1′,3′,3′-trimethylspiro[2H-1-benzopyran-2,2′-indoline], 1.23 g of styrene and 0.72 g of butyl methacrylate were dissolved in THF and 24 mg of the heat curing agent (1% by mol of 2,2-azobis(isobutyronitrile) was added. The resulting mixture was heat refluxed under a nitrogen stream for 48 hours. Thus prepared polymer was precipitated with the use of a mixed solvent of ether and hexane and then dried under reduced pressure at 50° C. to obtain a purified polymer in a yield of 50%. The glass transition temperature of the obtained polymer was 69° C., the weight average molecular weight 12000 and the dispersibility (M_{w}/Mₙ) 1.68. This polymer can be used as a photochromic polymer membrane due to its high solubility in organic solvents and high processability.

The data of the ¹H-NMR (CDCl₃) and IR spectrum of the thus obtained polymer are as follows:

IR (KBr, cm⁻¹): 1724 (—COO—), 955 (Cₛₚᵢᵣₒ—O);

¹H-NMR (300 MHz, CDCl₃): δ 7.79 (d, J=8.7 Hz), 7.60 (s), 7.3-6.5 (m, broad), 5.76 (d, J=10.3 Hz), 4.0-3.0 (m, br), 2.74(s), 2.3(br), 2.0-1.0 (m, br), 0.9-0.5 (m, br).

### Example 35

The same procedure as in Example 34 was repeated except that 0.082 g of 6-[4″-(6′″-(methacryloxyhexyloxyphenylcarbonyl)-1′,3′,3′-trimethylspiro[2H-1-benzopyran-2,2′-indoline] was used. The yield of thus obtained polymer was 1.05 g (56%) and the glass transition temperature was 66° C.

### Example 36

The same procedure as in Example 34 was repeated except that the reaction was conducted for 72 hours. The yield of the obtained polymer was 52% and the glass transition temperature was 70° C.

### Example 37

The same procedure as in Example 34 was repeated except that 3.13 g of 6-[4′-(6′″-(methacryloxyhexyloxyphenylcarbonyl)-1′,3′,3′-trimethylspiro[2H-1-benzopyran-2,2′-indoline] was used and the reaction was conducted for 24 hours. The yield of the obtained polymer was 40%, the weight average molecular weight 6000, the dispersibility 1.71 and the glass transition temperature 85° C. The obtained copolymer initiates decomposition at a temperature more than 242° C., which illustrates high thermal stability.

### Example 38

0.203 g of 6-[4″-(6′″-(methacryloxyhexyloxyphenylcarbonyl)-1′,3′,3′-trimethylspiro[2H-1-benzopyran-2,2 ′-indoline] prepared in Example 32 was mixed with 0.129 g of butyl methacrylate, 0.13 g of styrene and 0.5245 g of tripropylene glycol. To the resulting mixture, 0.04 g of dimethoxyphenylacetophenone (DMPA) was added. The resulting solution was applied to a glass plate and then exposed to the radiation of ultraviolet rays under a nitrogen stream for 5 minutes, thereby obtaining a polymer which is transparent and possesses excellent adhesive properties.

### Example 39

The same procedure as in Example 38 was repeated except that 6-[4″-(6′″-(methacryloxyhexyloxyphenylsulfanyl)-1′,3′,3′-trimethylspiro[2H-1-benzopyran-2,2′-indoline] prepared according to Example 33 was used to obtain a polymer.

### Examples 40 to 51

### Preparation of Photochromic Switch Thin Film

### Example 40

0.2 g of the spirobenzopyran group-containing copolymer prepared in Example 34 was added to 2 ml of xylene and the resulting solution was stirred at room temperature for 1 hour. The resulting solution was applied by a spin coater to a glass plate and dried in an oven of 50° C. under reduced pressure for 12 hours to obtain a transparent photochromic thin film. The obtained thin film changed color to blue when exposed to ultraviolet radiation wherein no formation of aggregate was found. No phase isolation was found when exposure to the light was repeatedly conducted.

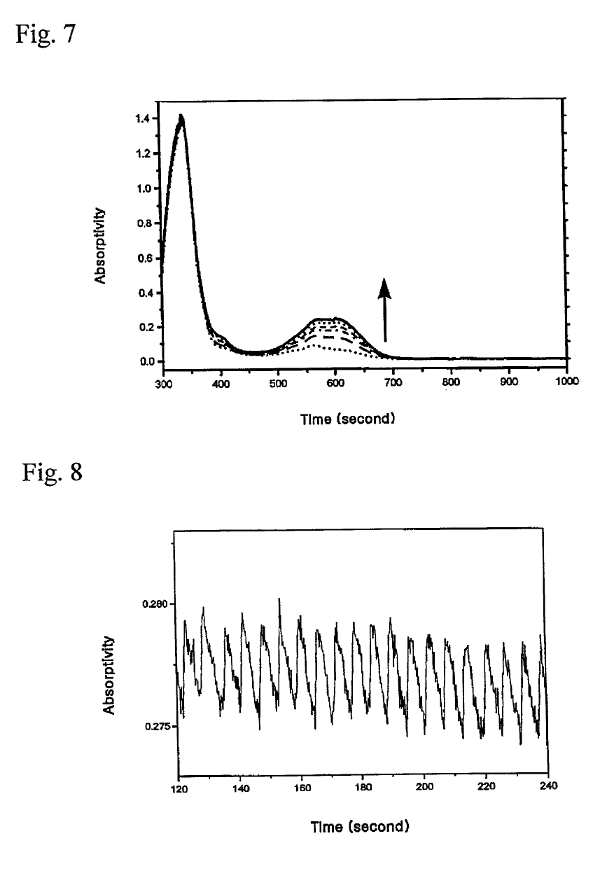

FIG. 7 illustrates a variation of absorption spectrum of thus obtained thin film when exposed to the radiation having a monochromatic wavelength of 340 nm.

FIG. 8 illustrates a variation of absorption spectrum of thus obtained thin film measured at a wavelength of 610 nm when exposed to the radiation having a monochromatic wavelength of 340 nm for 1 second and then the radiation was discontinued for 5 seconds. The rate of photo coloration and darkening [the efficiency of photo switch=100×change in absorbance when darkening is induced/change in absorption when photo coloration is induced] was 95 to 100%, respectively.

### Examples 41 to 51

A polymer thin film was prepared in the same manner as in Example 40 except that the copolymer and solvent used and the manufacturing conditions were changed as listed in Table 2 below.

In all the Examples, no phase isolation or aggregate formation were found when the composition was prepared, after the thin film was prepared or during the experiment of the photo switch. Furthermore, an aggregation phenomenon in polymer matrix was not observed.

The efficiencies of the photo switch illustrated when exposed to the radiation having a monochromatic wavelength of 340 nm for 1 second and then the radiation was discontinued for 5 seconds were summarized in Table 2 below.

TABLE 2

| | | | | | | Efficiency of |
|---|---|---|---|---|---|---|
| | Copolymer | | | | Coating method, | photo switch |
| Example | Used | (g) | Solvent | (mL) | Drying temp./time | (%) |
| 41 | Ex. 34 | 0.050 | THF | 1 | Spin coating, | 97 |
| | | | | | 50° C./3 hr. | |
| 42 | Ex. 35 | 0.2 | Xylene | 2 | Spin coating, | |
| | | | | | 50° C./12 hr. | |
| 43 | Ex. 36 | 0.5 | Toluene + Xylene | | Spin coating, | 95 |
| | | | (1:4) | | 50° C./12 hr. | |
| 44 | Ex. 36 | 0.1 | THF | 1 | Spin coating, | 99 |
| | | | | | 50° C./12 hr. | |
| 45 | Ex. 36 | 0.5 | Xylene | 2 | Bar coating, | 99 |
| | | | | | 50° C./12 hr. | |
| 46 | Ex. 36 | 0.5 | Xylene | 2 | Spin coating, | 96 |
| | | | | | 50° C./12 hr. | |
| | | | | | Spin coating again | |
| 47 | Ex. 36 | 0.5 | Xylene | 2.5 | Bar coating, | 97 |
| | | | | | 25° C./12 hr. | |
| 48 | Ex. 37 | 0.5 | Xylene | 2 | Spin coating, | 80 |
| | | | | | 50° C./12 hr. | |
| 49 | Ex. 37 | 0.5 | Xylene + Toluene | 2.5 | Spin coating, | 81 |
| | | | (4:1) | | 50° C./12 hr. | |
| 50 | Ex. 38 | — | — | — | Spin coating, | — |
| | | | | | 50° C./12 hr. | |
| 51 | Ex. 39 | — | — | — | Spin coating, | |
| | | | | | 50° C./12 hr. | |

### Example 52 [Comparative Example]

0.05 g of commercially available nitrospirobenzopyran compound was dissolved in 1 ml of chloroform and to the resulting solution, 0.95 g of polymethylmethacrylate was added and stirred at room temperature, thereby obtaining a spirobenzopyran compound composition exhibiting viscosity properties. Subsequently, a photochromic thin film was prepared in the same manner as in Example 40.

The efficiency of the photo switch when exposed to radiation having a monochromatic wavelength of 340 nm was approximately 70%. The rates of both photo coloration and darkening were slow. In addition, the formation of aggregate in said thin film was found in the case where thus obtained thin film was exposed to radiation for more than 1 hour. Therefore, the efficiency of the photo switch was slow.

Effects of the Invention

According to the present invention, there are provided spirobenzopyran compounds and spirobenzopyran group-containing polymers, which show high thermal stability due to their high thermal decomposition temperature as well as high processability. Photochromic compositions and photochromic switch thin films may also be prepared by using these compounds and polymers.

All of the numerical and quantitative measurements set forth in this application (including in the examples and in the claims) are approximations. For example, when the application refers to a temperature range from 30° C. to 150° C., the temperature range is actually from approximately 30° C. to approximately 150° C. Similarly, when the application refers to a range from 0.5 to 150 hours, the range is actually from approximately 0.5 to approximately 150 hours. The two preceding sentences set forth non-limiting examples because, as stated in the first sentence of this paragraph, all of the numerical and quantitative measurements set forth in this application (including in the examples and in the claims) are approximations.

What is claimed is:

1. A spirobenzopyran compound of the formula (1) and its derivatives: 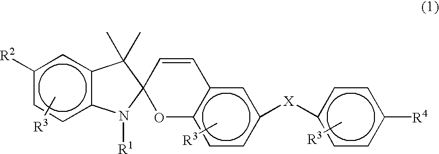
wherein R¹ is a linear or branched C₁₋₂₂ alkyl or alkenyl group, or a phenyl or phenylalkyl group, wherein said alkyl, alkenyl and phenyl groups may be substituted with a functional group such as a hydroxyl, a halide, a glysidoxy, an amine, a vinyl, an epoxy, a (meth)acryl, an amino or a mercapto group;
R² and R³ independently of one another are hydrogen, a halogen atom, a cyano group, a substituted amino group, a nitro group, or a linear or branched C₁₋₁₀ alkyl or alkoxy groups which may be substituted;
R₄ is hydrogen, a hydroxy, —R¹ or —OR¹ group, or —R⁵)ₙ—Z group wherein R⁵ is a C₁₋₂₂ alkylene which may be substituted and may contain in its carbon chain at least one hetero atom selected from the group consisting of carbon, sulfur and nitrogen, Z is a functional group such as a hydroxyl group, a halide group, a glysidoxy group, an amine group, a vinyl group, an epoxy group, a (meth)acryl group, an amino group or a mercapto group, and n is a number between 0 and 20; and
X is a divalent linking group and is —CO—, —S—, —SO₂—, —C≡C—, —O—, —C(R⁶)₂—, —C(R⁶)═C(R⁶)—, —N═N— or —NR⁶— wherein R⁶ is independently selected from the substituents defined for R¹, R² and R³.

2. A method of preparing a spirobenzopyran compound of formula (1) and its derivatives, which comprises reacting a carbonyl salicyl aldehyde of the formula (2) or its derivatives 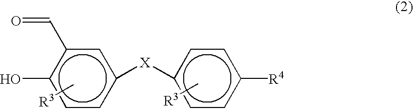
with an indoline of the formula (3) or its derivatives 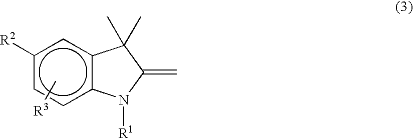
wherein the substituents have the same meaning as defined in claim 1.

3. The method according to claim 2 further comprising:
a compound having reactivity in R⁴ group among said compounds of formula (1) is reacted more than once with a compound of the formula (4)
R⁴OH or R⁴Z (4)
wherein R⁴and Z are as defined in claim 2, thereby obtaining a modified spirobenzopyran compound derivative.

4. A spirobenzopyran group-containing polymer, comprising units of formula (1a) derived from the spirobenzopyran compound according to claim 1: 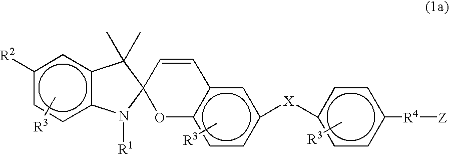
wherein R¹ is a linear or branched C₁₋₂₂ alkyl or alkenyl group, or a phenyl or phenylalkyl group, wherein said alkyl, alkenyl and phenyl groups may be substituted with a functional group such as a hydroxyl, a halide, a glysidoxy, an amine, a vinyl, an epoxy, a (meth)acryl, an amino or a mercapto group;
R² and R ³ independently of one another are hydrogen, a halogen atom, a cyano group, a substituted amino group, a nitro group, or a linear or branched C₁₋₁₀ alkyl or alkoxy groups which may be substituted;
R⁴ is a linear or branched C₁₋₂₂ alkylene or alkyleneoxy group which may contain in its carbon chain at least one hetero atom selected from the group consisting of oxygen, sulfur and nitrogen, wherein said alkylene portion is capable of being substituted with at least one substituent selected from the group consisting of a C₁₋₆ alkyl, an alkenyl, a hydroxyl, a halide, a glysidoxy, an amine, a vinyl, an epoxy, a (meth)acryl, an amino or a mercapto group;
Z is OH, halide group or a group having at least one unsaturated linkage; and
X is a divalent linking group and is —CO—, —S—, —SO₂—, —C≡C—, —O—, —C(R⁶)₂—, —C(R⁶)═C(R⁶)—, —N═N— or —NR⁶— wherein R⁶ may independently be selected from the substituents defined for R¹, R² and R³.

5. The spirobenzopyran group-containing polymer according to claim 4 wherein Z is a hydroxy, a halide or a vinyl or (meth)acryl group.

6. A method for the preparation of a spirobenzopyran group-containing polymer, which comprises polymerizing by either heat curing or light curing in the presence of an initiator and in the presence or absence of solvent, a spirobenzopyran monomer of the formula (1a) 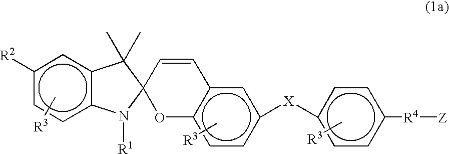
and as a comonomer, at least one unsaturated functional group-containing monomer selected from the group consisting of the compounds of the formula (200) 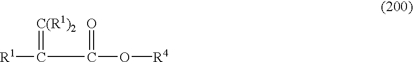
and compounds of the formula (300) 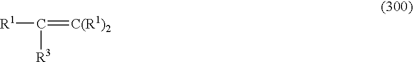
wherein R¹, R², R³, R⁴, and X have the same meaning as defined in claim 4 and Z is a group having at least one unsaturated linkage.

7. A composition comprising at least one spirobenzpyran group-containing monomer according to claim 1, a solvent or solvents, an optional polymer, or a mixture of them.

8. A thin film obtained by coating to a support the composition according to claim 7 comprising at least one spirobenzpyran group-containing monomer.

9. An article such as display elements, photochromic filters, photo switches, photosensitive drums, recording elements, solar batteries, lenses, cosmetics, fibers or optical elements, characterized by comprising at least one spirobenzpyran group-containing monomer according to claim 1.

10. A composition comprising at least one spirobenzpyran group-containing polymer according to claim 4, a solvent or solvents, an optional monomer, or a mixture thereof.

11. An article such as display elements, photochromic filters, photo switches, photosensitive drums, recording elements, solar batteries, lenses, cosmetics, fibers or optical elements, characterized by comprising at least one spirobenzpyran group-containing polymer according to claim 4.
